(19) United States
(12) Patent Application Publication
(10) Pub. No.: US 2005/0289330 A1
(43) Pub. Date: Dec. 29, 2005

(54) Branch control method and information processor

(75) Inventor: Masayuki Yamasaki, Osaka (JP)

Correspondence Address: MCDERMOTT WILL & EMERY LLP, 600 13TH STREET, N.W., WASHINGTON, DC, 20005-3096, US

(73) Assignee: Matsushita Electric Industrial Co., Ltd.

(21) Appl. No.: 11/157,920

(22) Filed: Jun. 22, 2005

(30) Foreign Application Priority Data
Jun. 24, 2004 (JP) 2004-186568

(51) Int. Cl. G06F 15/00

(52) U.S. Cl. 712/234

(57) ABSTRACT

An object of the present invention is to provide a branch control method and an information processor in which when an instruction that can be processed in a delayed slot is present, a delayed branch is implemented to eliminate a branch hazard, and even when there is no such an instruction that can be processed in the delayed slot, the program is not increased in size because insertion of NOP into instruction memory is not necessary. To achieve this object, in an information processor which performs pipeline processing of instructions, branch operation is controlled as follows. When a conditional branch instruction is executed, whether or not to implement a delayed branch is determined according to whether or not the branch condition is satisfied and the value of a given control filed contained in an instruction code located at an address successive to the conditional branch instruction. When it is determined that no delayed branch is implemented and the branch condition is satisfied, the successive instruction is fetched but is not executed, while an instruction at a branch destination is fetched and executed. When it is determined that no delayed branch is implemented and the branch condition is not satisfied, the instruction successive to the branch instruction is executed.

### CROSS-REFERENCE TO RELATED APPLICATION

This Non-provisional application claims priority under 35 U.S.C. §119(a) on Patent Application No. 2004-186568 filed in Japan on Jun. 24, 2004, the entire contents of which are hereby incorporated by reference.

### BACKGROUND OF THE INVENTION

1. Field of the Invention

The present invention relates to an information processor which performs pipeline processing of instructions, and a method for controlling branching in the information processor.

2. Description of the Prior Art

In an information processor which performs pipeline processing of instructions, when the instructions are sequentially supplied to the pipeline and executed one after another, the speed of executing the instructions is enhanced by overlapping the execution of the instructions. However, in the case of pipeline processing of a conditional branch instruction, a determination of which address is to be fetched next cannot be made until the completion of the decoding of the conditional branch instruction at the earliest. This may lead to the problem of the occurrence of an empty slot (branch hazard).

As a means for overcoming this problem, a branch method, which is called a delayed branch, is employed. In the branch method, an instruction code stored at an address subsequent to a conditional branch instruction is processed in an empty slot (delayed slot) successive to that conditional branch instruction, thereby eliminating a branch hazard (see, for example, Japanese Laid-Open Publication No. 4-127237 and pp. 265-270 in “Computer Architecture” by David Paterson and John Hennessy, 1st edition, 1st printing (revised), Feb. 18, 1994, Nikkei BP Publishing Center, Inc.) In this method, the instruction processed in the delayed slot is executed in the cycle in which a branch hazard would otherwise occur, such that the number of cycles required to execute the conditional branch instruction is reduced apparently.

In the method described above, the instruction stored at the address successive to the conditional branch instruction has to be an instruction that can be processed (fetched, decoded, and executed) at points in time after the conditional branch instruction is processed, or an instruction that can be executed irrespective of whether or not the branch condition in the conditional branch instruction is satisfied. Due to this restriction on the instruction stored at the successive address and processed in the delayed slot, if there is no such an instruction that can be stored at the successive address, NOP (No Operation: an invalidation instruction) is stored instead.

However, the NOP is stored in addition to the instruction that is to be executed, thereby causing a problem in that the program often increases in size.

### SUMMARY OF THE INVENTION

The present invention has been made in view of the above problem, and it is therefore an object of the present invention to provide a branch control method and an information processor in which when an instruction that can be processed in a delayed slot is present, a delayed branch is implemented to eliminate a branch hazard, and even when there is no instruction that can be processed in the delayed slot, NOP does not have to be inserted in the program, such that the program does not increase in size.

In order to achieve the above object, an inventive branch control method for controlling branch operation performed by a branch instruction in an information processor that performs pipeline processing in which instructions stored in storing means are fetched sequentially includes: a discrimination step for discriminating, based on branch-control instruction information contained in an instruction code, between a first control mode, in which a succeeding instruction fetched following the branch instruction from an address successive to the branch instruction is executed regardless of whether or not a branch condition in the branch instruction is satisfied, and a second control mode, in which the succeeding instruction is executed when the branch condition is not satisfied; and a control step for performing control in such a manner that in the first control mode, the fetched succeeding instruction is executed, while branch control is performed according to whether or not the branch condition is satisfied, in the second control mode, if the branch condition is satisfied, the succeeding instruction is fetched but is not executed, while an instruction at a branch destination is fetched and executed, and in the second control mode, if the branch condition is not satisfied, the succeeding instruction is executed.

In one embodiment of the present invention, in the control step, control is performed in such a manner that in the second control mode, if the branch condition is not satisfied, the succeeding instruction is fetched following the branch instruction, and is executed.

In another embodiment of the present invention, in the control step, control is performed in such a manner that in the second control mode, if the branch condition is not satisfied, the succeeding instruction is fetched following the branch instruction, but is not executed, and thereafter the succeeding instruction is fetched again and executed.

In still another embodiment, the branch-control instruction information is contained in an instruction code of the instruction at the address successive to the branch instruction.

According to the inventive method, when an instruction which is executed regardless of whether or not the branch condition is satisfied is not stored at the address successive to the branch instruction, it is determined in the discrimination step that the second control mode is indicated, based on the branch-control instruction information, and then branch control is performed in a simple manner: when the branch condition is not satisfied, the fetched succeeding instruction is executed without interruption, thereby allowing the high-speed execution of the succeeding instruction, or the fetched succeeding instruction is not executed.

In still another embodiment, the succeeding instruction contains instruction-execution-condition information that indicates one or more instruction execution conditions for execution of the instruction; in the control step, control is performed in such a manner that in the second control mode, if the branch condition is not satisfied and the one or more instruction execution conditions of the succeeding instruction are satisfied, the instruction is executed; and in the discrimination step, it is determined that the first control mode is indicated, when the instruction-execution-condition information has a predetermined value.

Then, in the discrimination step, it is determined which one of the first and second control modes is indicated, in accordance with the form of the instruction whose execution is controlled according to the execution conditions.

In still another embodiment, the succeeding instruction contains instruction-execution-condition information that indicates one or more instruction execution conditions for execution of the instruction; and in the control step, control is performed in such a manner that in the first control mode, if the one or more instruction execution conditions of the succeeding instruction are satisfied, the instruction is executed, and in the second control mode, if the branch condition is not satisfied and the one or more instruction execution conditions are satisfied, the succeeding instruction is executed.

Then, in each of the first and second control modes, the execution of the instruction is controlled according to the execution conditions.

In still another embodiment, the succeeding instruction contains instruction-execution-condition information that indicates one or more instruction execution conditions for execution of the instruction; and in the discrimination step, the discrimination between the first control mode and the second control mode is made according to whether the instruction-execution-condition information of the succeeding instruction agrees with the branch condition of the branch instruction.

Then, the discrimination between the first control mode and the second control mode is made according to whether the instruction-execution-condition information of the succeeding instruction agrees with the branch condition of the branch instruction.

In yet another embodiment, in the control step, control is performed in such a manner that in the first control mode, the succeeding instruction is executed regardless of the instruction-execution-condition information.

Then, control is performed in such a manner that in the first control mode, the succeeding instruction is executed regardless of the instruction-execution-condition information.

In yet another embodiment, in the discrimination step, it is determined that the first control mode is indicated, when the instruction-execution-condition information of the succeeding instruction agrees with the branch condition of the branch instruction; and in the control step, in the first control mode, whether or not to execute the succeeding instruction is controlled according to the instruction-execution-condition information.

Then, it is determined that the first control mode is indicated when the instruction-execution-condition information of the succeeding instruction agrees with the branch condition of the branch instruction, and whether or not to execute the succeeding instruction is controlled according to the instruction-execution-condition information.

Also, an inventive information processor which performs pipeline processing of instructions includes: a fetch section for sequentially fetching the instructions stored in storing means; a decoding section for decoding the fetched instructions; an instruction execution section for executing the decoded instructions; discrimination means for discriminating, based on branch-control instruction information contained in an instruction code, between a first control mode, in which a succeeding instruction fetched following a branch instruction from an address successive to the branch instruction is executed regardless of whether or not a branch condition in the branch instruction is satisfied, and a second control mode, in which the succeeding instruction is executed when the branch condition is not satisfied; and control means for performing control in such a manner that in the first control mode, the fetched succeeding instruction is executed, while branch control is performed according to whether or not the branch condition is satisfied, in the second control mode, if the branch condition is satisfied, the succeeding instruction is fetched but is not executed, while an instruction at a branch destination is fetched and executed, and in the second control mode, if the branch condition is not satisfied, the succeeding instruction is executed.

In the inventive information processor, when an instruction which is executed regardless of whether or not the branch condition is satisfied is not stored at the address successive to the branch instruction, it is determined by the discrimination means that the second control mode is indicated, based on the branch-control instruction information, and whether or not to execute the succeeding instruction is controlled according to whether or not the branch condition is satisfied.

### BRIEF DESCRIPTION OF THE DRAWINGS

FIG. 1 illustrates the configuration of an instruction code according to a first embodiment.

FIG. 2A illustrates a state in which instruction codes are stored in an instruction memory in the first embodiment.

FIG. 2B illustrates an order in which the instruction codes (in which DF=0) are executed in the first embodiment.

FIG. 2C illustrates an order in which the instruction codes (in which DF≠0) are executed in the first embodiment.

FIG. 3 schematically illustrates operation of an information processor according to the first embodiment.

FIG. 4A shows a specific example indicating how the instruction codes are stored when a delayed branch is implemented in the first embodiment.

FIG. 4B illustrates an order in which the instruction codes are processed when the delayed branch is implemented in the first embodiment.

FIG. 5A shows a specific example indicating how the instruction codes are stored when no delayed branch is implemented in the first embodiment.

FIG. 5B illustrates an order in which the instruction codes are processed when no delayed branch is implemented in the first embodiment.

FIG. 6 illustrates the configuration of an instruction code according to a second embodiment.

FIG. 7A shows how instruction codes are stored in an instruction memory in the second embodiment.

FIG. 7B illustrates an order in which the instruction codes (in which CF=0000) are processed in the second embodiment.

FIG. 7C illustrates an order in which the instruction codes (in which CF≠0000) are processed in the second embodiment.

FIG. 8 schematically illustrates how an information processor according to the second embodiment operates.

FIG. 9 illustrates the configuration of an instruction code according to a third embodiment.

FIG. 10A shows how instruction codes are stored in an instruction memory in the third embodiment.

FIG. 10B illustrates an order in which the instruction codes (in which VF=???0) are processed in the third embodiment.

FIG. 10C illustrates an order in which the instruction codes (in which VF≠???0) are processed in the third embodiment.

FIG. 11 schematically illustrates how an information processor according to the third embodiment operates.

FIG. 12 illustrates the configuration of an instruction code according to a fourth embodiment.

FIG. 13A shows how instruction codes are stored in an instruction memory in the fourth embodiment.

FIG. 13B illustrates an order in which the instruction codes (in which DCF=BCF) are processed in the fourth embodiment.

FIG. 13C illustrates an order in which the instruction codes (in which DCF≠BCF) are processed in the fourth embodiment.

FIG. 14 schematically illustrates how an information processor according to the fourth embodiment operates.

FIG. 15 illustrates the configuration of an instruction code according to a fifth embodiment.

FIG. 16 schematically illustrates how an information processor according to the fifth embodiment operates.

FIG. 17A shows how instruction codes are stored in an instruction memory in the fifth embodiment.

FIG. 17B illustrates an order in which the instruction codes (in which DCF=BCF) are processed in the fifth embodiment.

FIG. 17C illustrates an order in which the instruction codes (in which DCF≠BCF) are processed in the fifth embodiment.

FIG. 18A is a timing chart indicating a pipeline (in which branch-condition determination stage is a DC stage) in an information processor according to the present invention.

FIG. 18B is a timing chart indicating a pipeline (in which branch-condition determination stage is an EX stage) in an information processor according to the present invention.

### DESCRIPTION OF THE PREFERRED EMBODIMENTS

Hereinafter, preferred embodiments of the present invention will be described with reference to the accompanying drawings.

### First Embodiment

An information processor, in which instruction branching is controlled by a control method according to the present invention, includes an instruction read section, an instruction decoding section, an instruction execution section, and a control section for controlling instructions to be executed or the like. The information processor performs three-stage pipeline processing, in which instruction codes stored in memory are simultaneously fetched (IF stage), decoded (DC stage), and executed (EX stage).

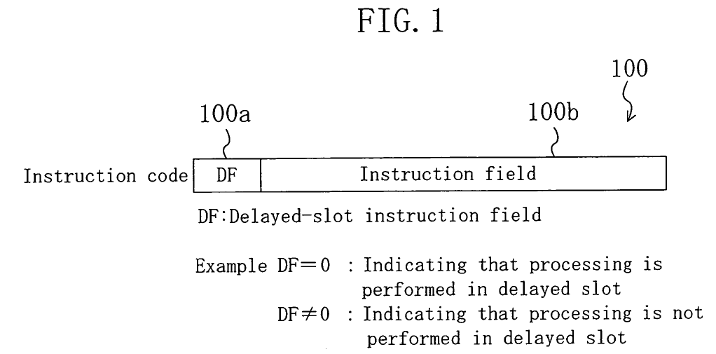

When a conditional branch instruction is executed, the control section controls operation of each of the above-mentioned sections based on whether or not the branch condition is satisfied and the value of a predetermined control filed contained in an instruction code. As shown in FIG. 1, for example, the value of the predetermined control filed is set to the value DF of a delayed slot instruction field 100a. The delayed slot instruction field 100a is contained in an instruction code 100 stored next to the conditional branch instruction, together with an instruction field 100b that indicates the content of the instruction.

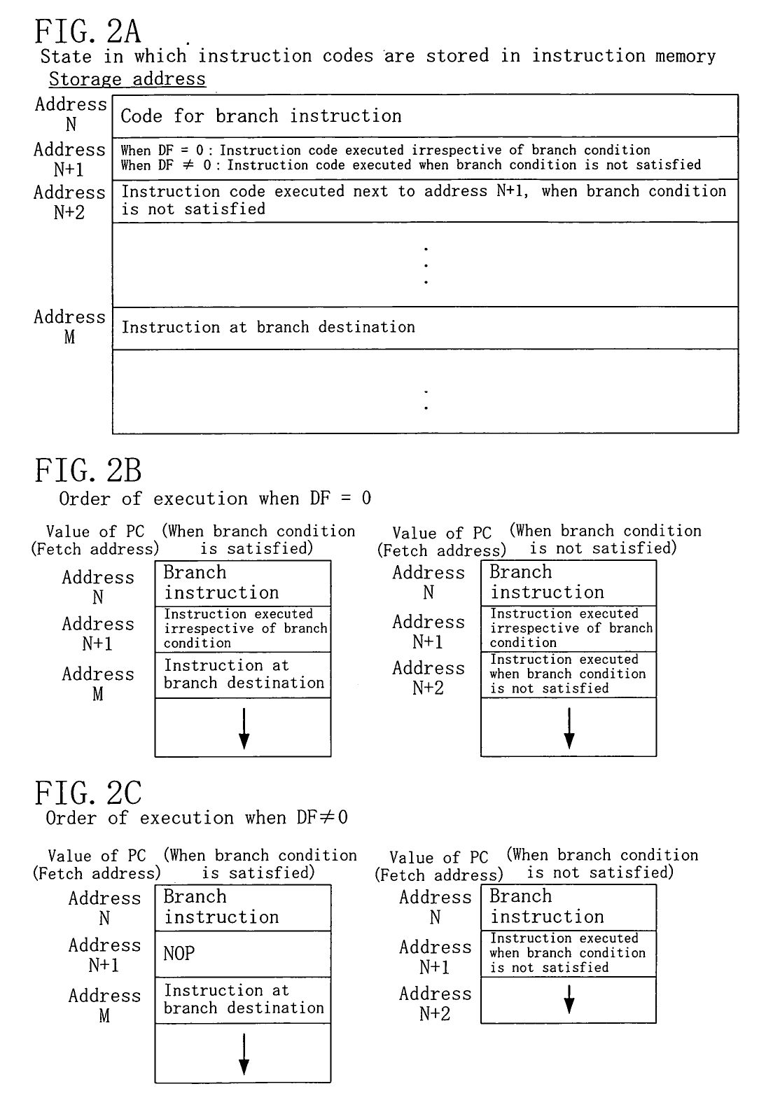

Specifically, as shown in FIG. 2A, for example, in a case where an instruction code for a conditional branch instruction is stored at an address (N), if an instruction code DF=0 is stored at an address (N+1), the instruction at the address (N+1) is fetched, decoded, and executed irrespective of the branch condition, as shown in FIG. 2B. Also, when the branch condition is satisfied, an instruction at an address M, which is a branch destination, is fetched, decoded, and executed. On the other hand, when the branch condition is not satisfied, an instruction at an address (N+2) is fetched, decoded, and executed. In this manner, an instruction that can be processed (fetched, decoded, and executed) at points in time after the conditional branch instruction is processed, or an instruction (which is typically an instruction that is processed prior to the conditional branch) that is executed irrespective of whether or not the branch condition is satisfied, is stored at the address (N+1), while by the above-described operation, the pipeline processing is performed at high speed without causing waste.

More specifically, when the conditional branch instruction at the address (N) is decoded after it is fetched, the instruction code at the address (N+1), which is processed regardless of the branch condition, is fetched. At the point in time when the decoding of the conditional branch instruction and the fetch of the subsequent instruction have been performed, it is determined, based on the decoding result of the conditional branch instruction, whether or not the branch condition is satisfied, while it is determined that DF=0, from the instruction code fetched from the address (N+1). Thereafter, depending upon whether or not the branch condition is satisfied, either the instruction at the address (N+2) or the instruction at the address (M) is fetched and decoded, while the instruction code at the address (N+1) is decoded and executed.

As also shown in FIG. 2A, suppose a case in which an instruction code for a conditional branch instruction is stored at the address (N), while an instruction code DF≠0 is stored at the address (N+1). In this case, as shown in FIG. 2C, if the branch condition is satisfied, the instruction at the address (N+1) is fetched, but then replaced with a NOP instruction in the decoding section or operation of the execution section is stopped. As a result, an operation, which is the same as that performed when a NOP instruction is fetched, is carried out, and then the instruction at the branch-destination address (M) is fetched, decoded, and executed. Also, when the branch condition is not satisfied, the instruction at the address (N+1) is fetched, decoded, and executed. Therefore, even if the instruction that is processed only when the branch condition is not satisfied is stored at the address (N+1), the appropriate processing is carried out.

To be more specific, as in the case where DF=0, when the conditional branch instruction at the address (N) is decoded after it is fetched, the instruction code at the address (N+1) is fetched, but at this point in time, it is unknown whether or not the branch condition is satisfied. Therefore, after the instruction at the address (N+1) is fetched, if the branch condition is satisfied, the execution is blocked so as to prevent the inappropriate execution from being performed. On the other hand, when the branch condition is not satisfied, the blocking of the execution of the instruction at the address (N+1) is not performed, thereby allowing the appropriate execution to be performed.

In the above case of DF≠0, after the instruction at the address (N+1) is fetched, the execution of that instruction may be blocked as in the case where the branch condition is satisfied, even if the branch condition is not satisfied, and the instruction at the address (N+1) may be again fetched, decoded, and executed.

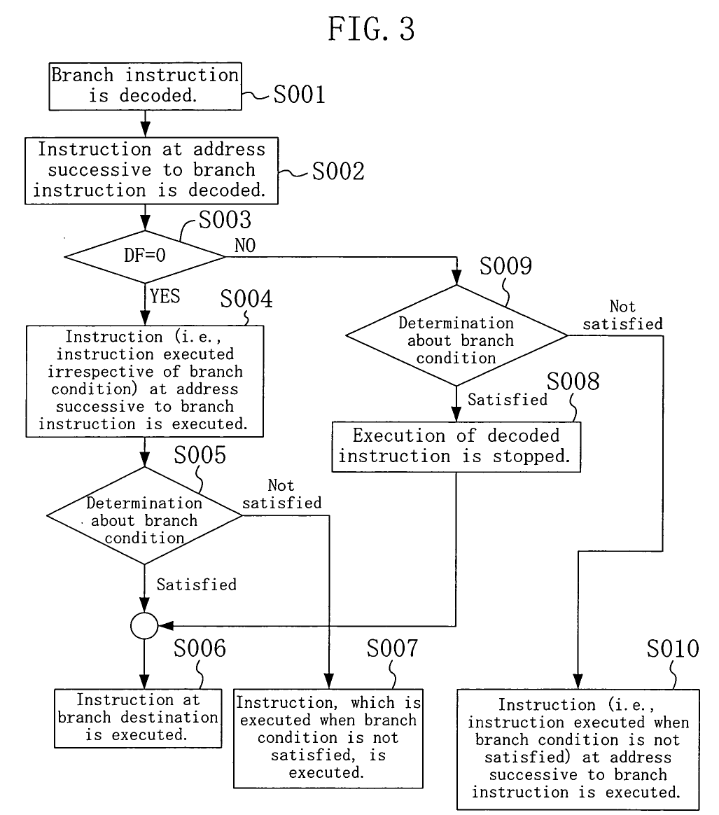

FIG. 3 shows exemplary operations performed according to the value of FD and whether or not the branch condition is satisfied. FIG. 3 schematically indicates the operation of the information processor in the form of a flow chart, but it is not meant that the operations in the respective steps are carried out in the order shown in FIG. 3. The specific operations will be described in the following.

(1) Step 1: S001

A fetched conditional branch instruction is decoded.

(2) Step 2: S002

An instruction fetched from an address (N+1) is decoded.

(3) Step 3: S003

It is determined whether or not DF (delayed-slot instruction filed 100a) is “0”. If it is “0”, the procedure goes to Step 4 (S004). If it is not “0”, the procedure goes to Step 9 (S009).

(4) Step 4: S004

The instruction at the address subsequent to the conditional branch instruction is executed.

(5) Step 5: S005

It is determined whether or not the branch condition in the conditional branch instruction is satisfied. If it is satisfied, the procedure goes to Step 6 (S006). If it is not satisfied, the procedure goes to Step 7 (S007).

(6) Step 6: S006

An instruction at a branch destination is fetched, decoded, and executed.

(7) Step 7: S007

An instruction, which is executed if the branch condition is not satisfied, is fetched, decoded, and executed.

(8) Step 8: S008

The execution of the instruction decoded in S002 is blocked.

(9) Step 9: S009

It is determined whether or not the branch condition in the conditional branch instruction is satisfied. If it is satisfied, the procedure goes to Step 8 (S008). If it is not satisfied, the procedure goes to Step 10 (S010).

(10) Step 10: S010

The instruction code at the address subsequent to the conditional branch instruction is again fetched, decoded, and executed.

Next, a specific example of the program processed by the information processor will be described.

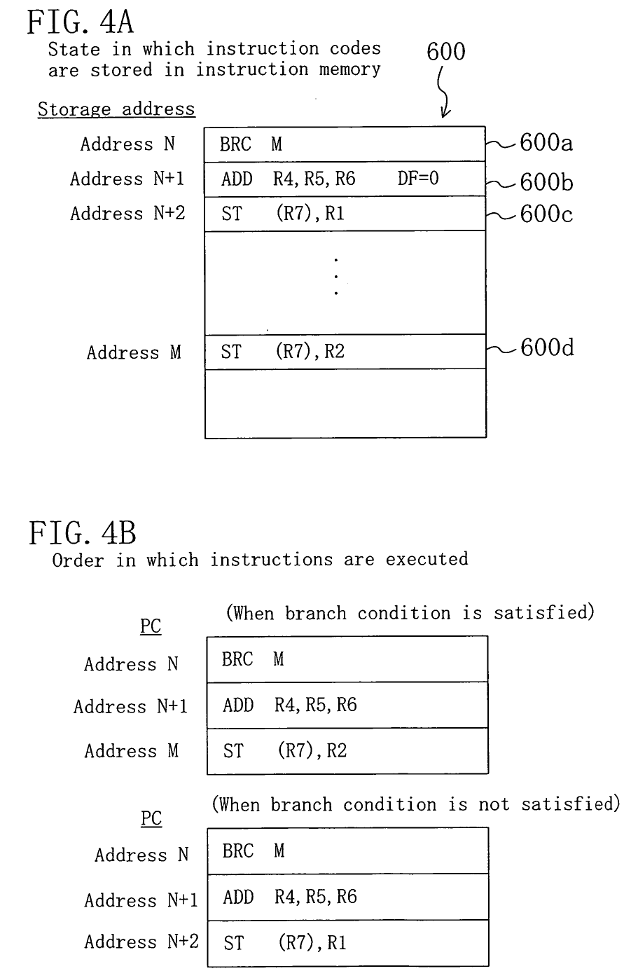

FIG. 4A indicates a specific example in which an instruction code at an address (N+1) is set to DF=0 in this embodiment. In this example, in an instruction memory 600, a conditional branch instruction 600a is stored at an address (N), an ADD instruction 600b is stored at an address (N+1), a STORE instruction 600c is stored at an address (N+2), and a STORE instruction 600d is stored at an address (M) as a branch-destination instruction. The ADD instruction 600b is an instruction that can be processed at a point in time after the conditional branch instruction is processed, irrespective of whether or not the branch condition is satisfied. The STORE instruction 600c is an instruction that is executed when the branch condition is not satisfied. In the program thus configured, the instruction codes are fetched, decoded, and executed according to whether or not the branch condition is satisfied, in the order shown in FIG. 4B. Therefore, the branch processing (delayed branch) is performed at high speed without casing an empty in the stages of the pipeline.

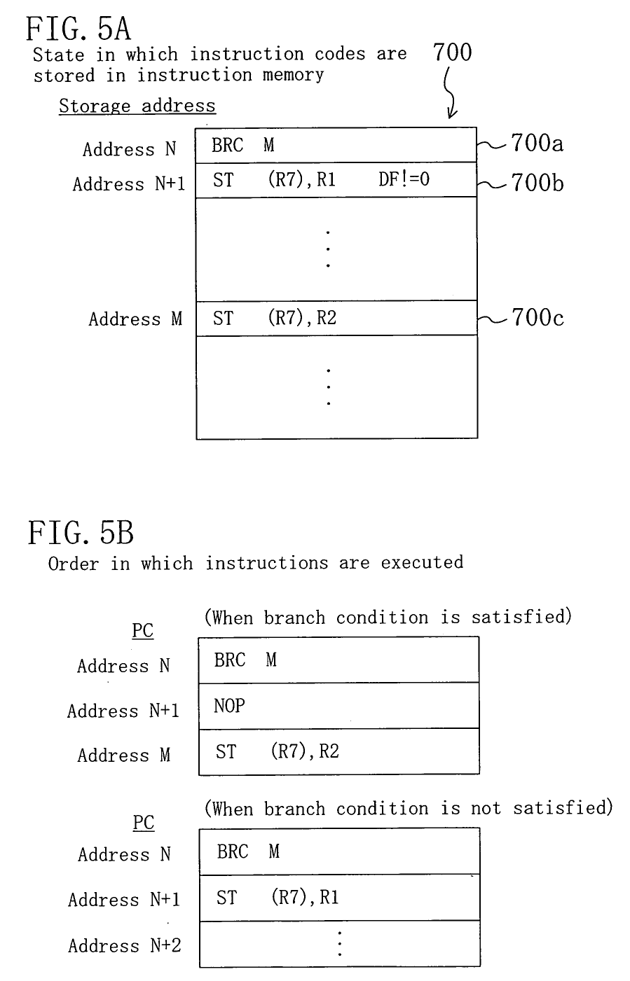

On the other hand, FIG. 5 indicates a specific example in which an instruction code at an address (N+1) is set to DF≠0. In this example, in an instruction memory 700, a conditional branch instruction 700a is stored at an address (N), a STORE instruction 700b is stored at an address (N+1), and a STORE instruction 700c is stored at an address (M) as a branch-destination instruction. In this case, the instruction codes are also fetched, decoded, and executed according to whether or not the branch condition is satisfied, in the order shown in FIG. 5B. Therefore, an operation, which would be performed if the original program contained NOP, is carried out. However, since the program does not need to contain any NOP, the program is reduced in size.

### Second Embodiment

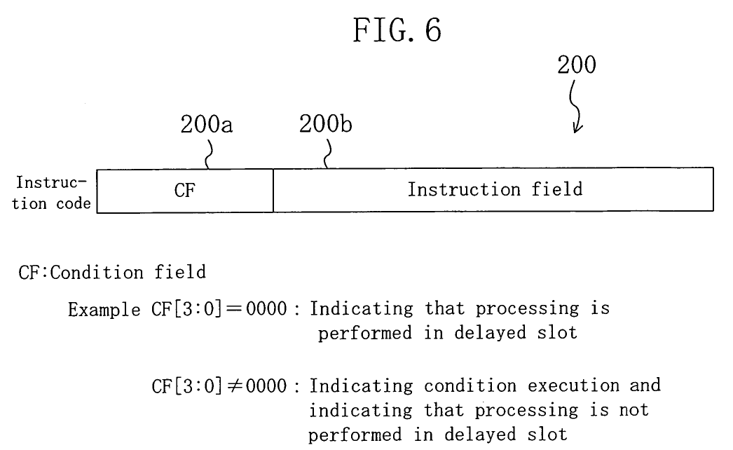

Instead of the instruction code 100, an instruction code 200 (conditional execution instruction), which contains a condition field 200a (CF) and an instruction field 200b as shown in FIG. 6, may be employed. In the condition field 200a, execution conditions for the instruction are specified. In the following embodiments, members having the same functions as those described in the first embodiment or the like are identified by the same reference numerals, and the descriptions thereof will be thus omitted herein.

When the instruction code 200 is stored at an address successive to a conditional branch instruction, the condition field 200a is used in the same manner as the delayed-slot instruction field 100a described in the first embodiment, while the condition field 200a is used as a condition field in which information on the execution of the instruction is stored, when the instruction code 200 is fetched again and executed.

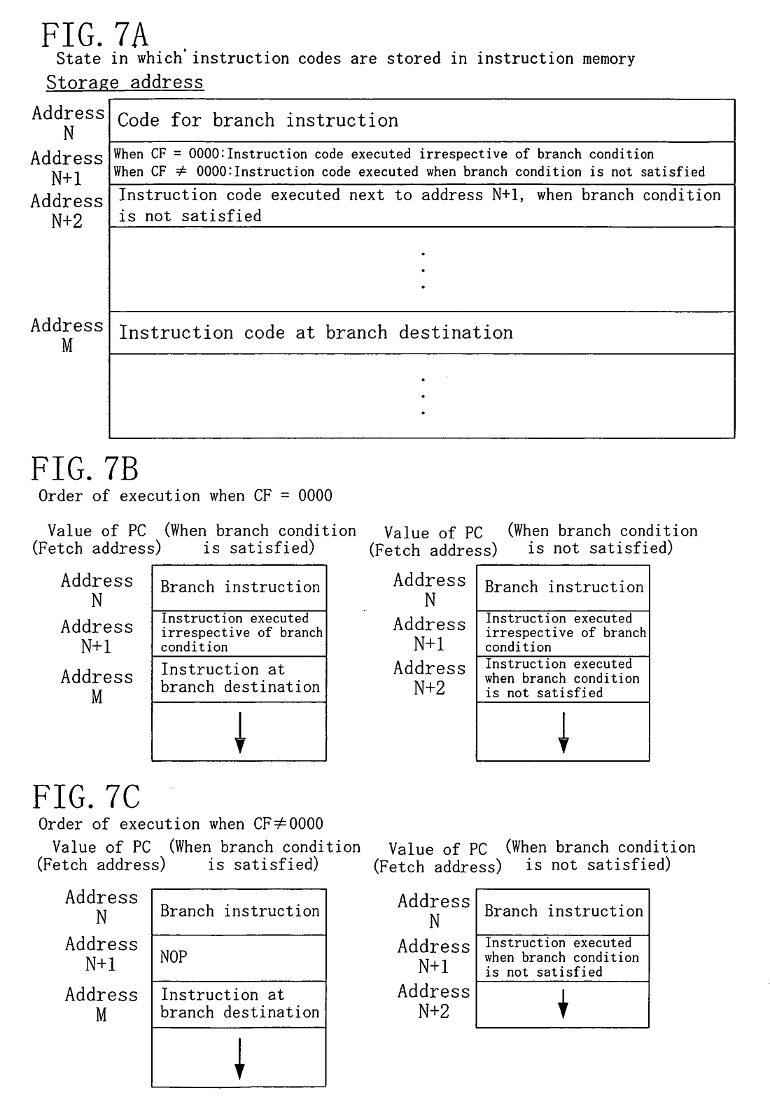

Specifically, as shown in FIG. 7A, the value CF of the condition field 200a in the instruction code stored at an address (N+1) is set to, e.g., CF=“0000”, if that instruction code is one that is executed irrespective of whether or not the branch condition in the conditional branch instruction is satisfied. On the other hand, when the instruction code is one that is executed only when the branch condition is not satisfied, the value CF is set to CF≠“0000”.

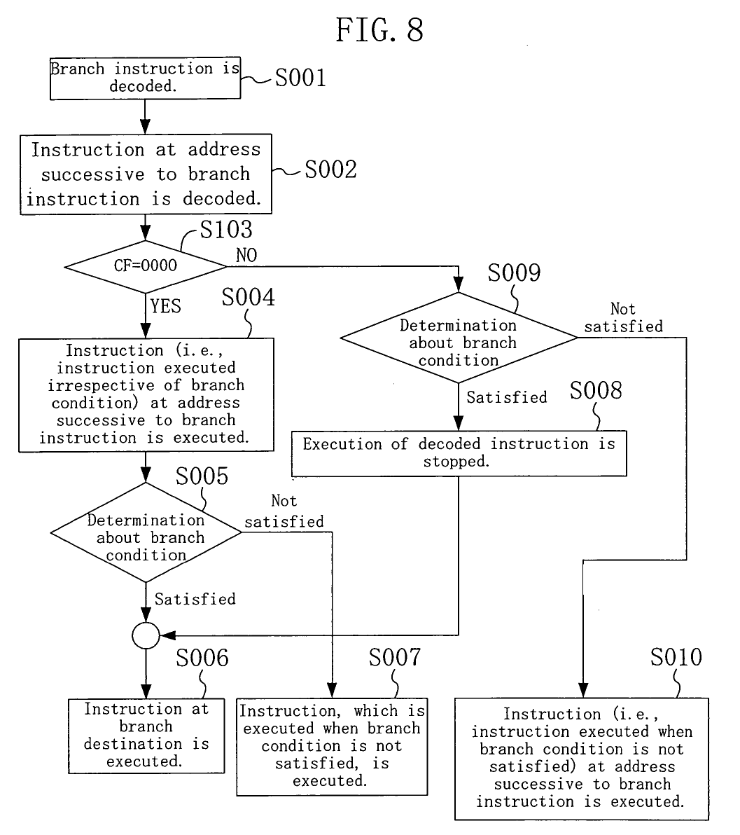

As a result, in the case where the value CF is set to CF=“0000”, a control operation that is almost the same as the operation described in the first embodiment is performed according to a determination made in (S103) as shown in FIG. 8, whereby the instruction codes are processed in the order shown in FIG. 7B. Also, even in the case where the value CF is set to CF≠“0000”, a control operation that is almost the same as the operation described in the first embodiment is performed, whereby the instruction codes are processed in the order shown in FIG. 7C. However, whether or not the instruction at the address (N+1), which is performed in S010 when the branch condition is not satisfied, is actually executed is controlled according to the value CF.

Therefore, in this embodiment as in the first embodiment, high-speed branch processing is carried out with the program size minimized, while whether or not a delayed branch is implemented is controlled based on whether or not the value of the condition field is a given value, thereby preventing the instruction code length from increasing.

### Third Embodiment

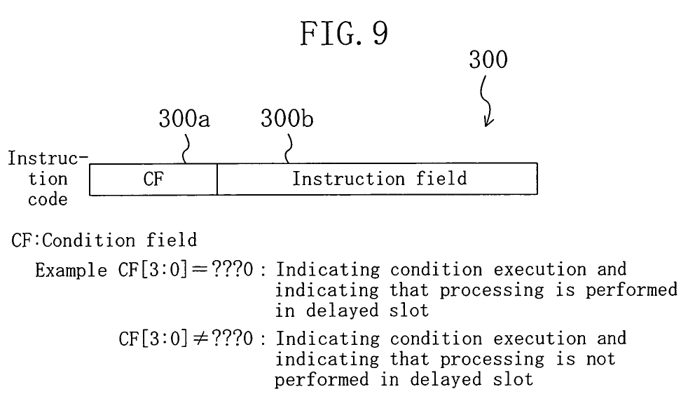

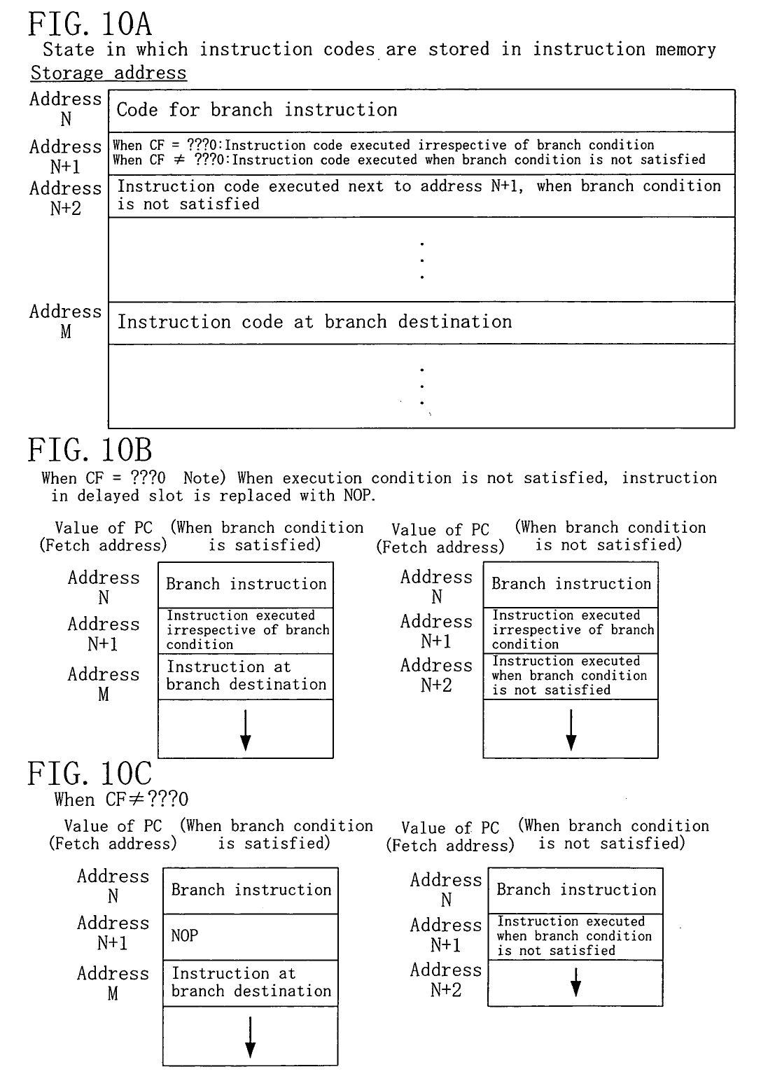

An instruction code 300 (conditional execution instruction) containing a condition filed 300a (CF) and an instruction field 300b shown in FIG. 9 may be employed, and the value of the condition field 300a may be set as shown in FIG. 10A. Specifically, when the instruction successive to a conditional branch instruction is an instruction that is executed irrespective of whether or not the branch condition is satisfied, the value of the condition field 300a may be set to, e.g., CF=“???0” (in which an execution condition is established in the portion “???”). If the instruction successive to the conditional branch instruction is an instruction that is executed only when the branch condition is not satisfied, the value of the condition field 300a may be set to, e.g., CF≠“???0”.

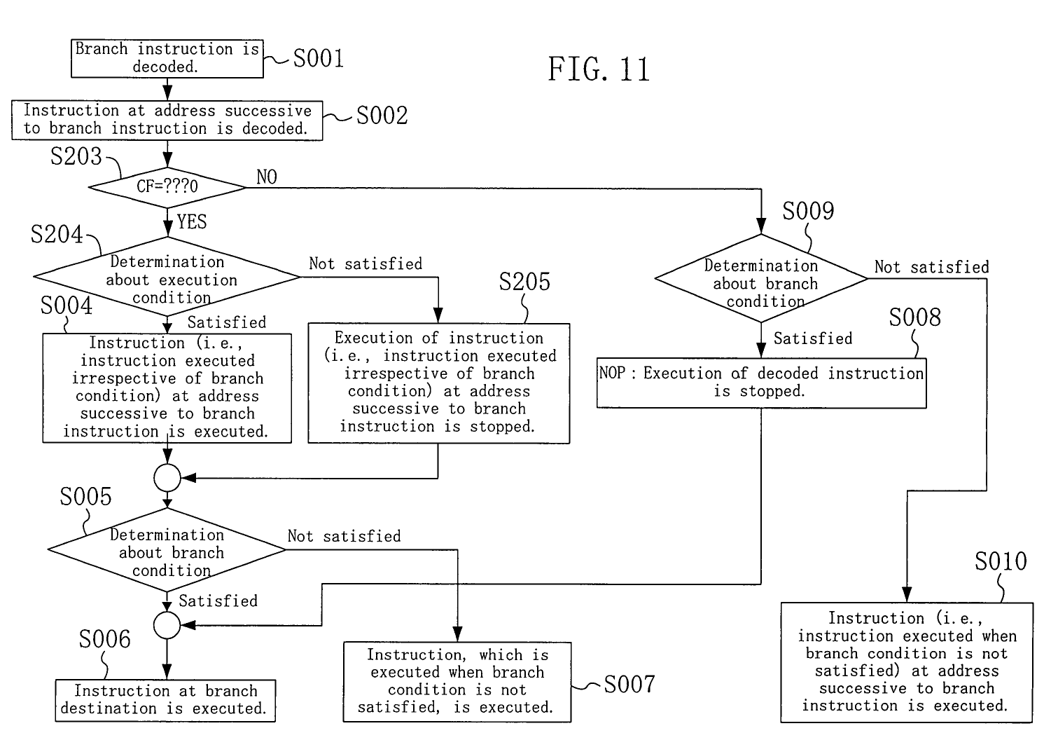

More specifically, as shown in FIG. 11, whether or not a delayed branch is implemented may be controlled based on whether or not the last digit of CF is 0 (S203), while control may be performed using the high-order digits of CF in such a manner that a so-called conditional execution is performed both in the case in which the delayed branch is implemented (S204, S205, S004) and in the case in which a normal branch is caused (S010). This enables the instruction codes to be processed in orders similar to those described in the first and second embodiments as shown in FIGS. 10B and 10C, while permitting the conditional execution to be performed for the instruction code stored at the address (N+1).

Consequently, as described in the second embodiment, high-speed branch processing is achieved with the program size minimized, while the instruction code length is prevented from increasing. Moreover, even in the case of a delayed branch, it is possible to perform a conditional execution.

### Fourth Embodiment

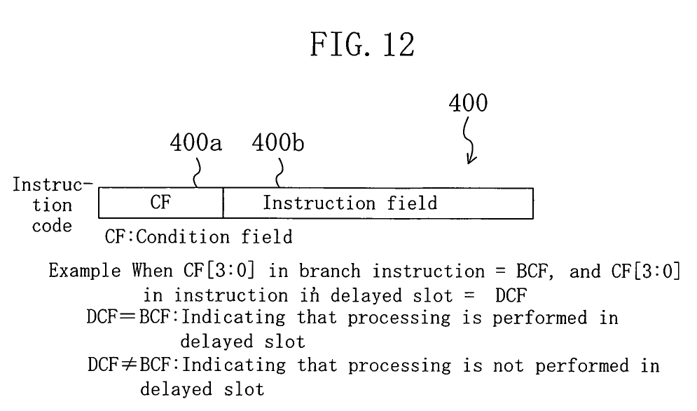

As shown in FIG. 12, by using an instruction code 400 containing a condition field 400a and an instruction code 400b, branch operation may be controlled by comparing a branch condition (BCF) in a conditional branch instruction and an execution condition (DCF) in the instruction code located at the address subsequent to the conditional branch instruction.

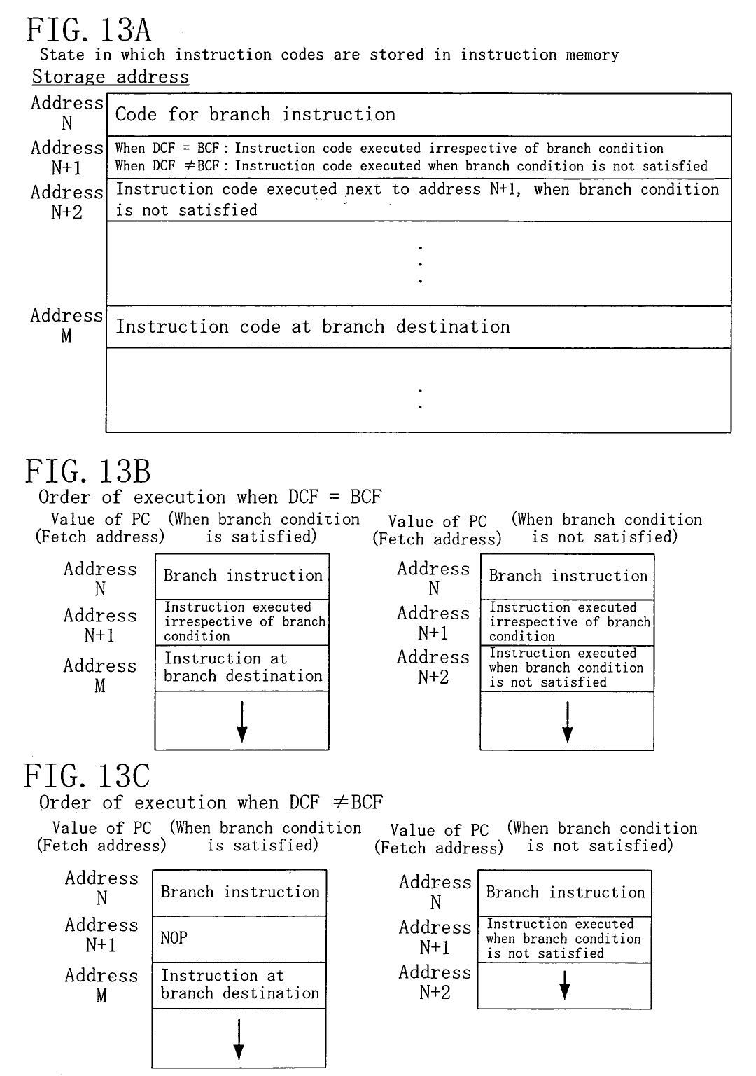

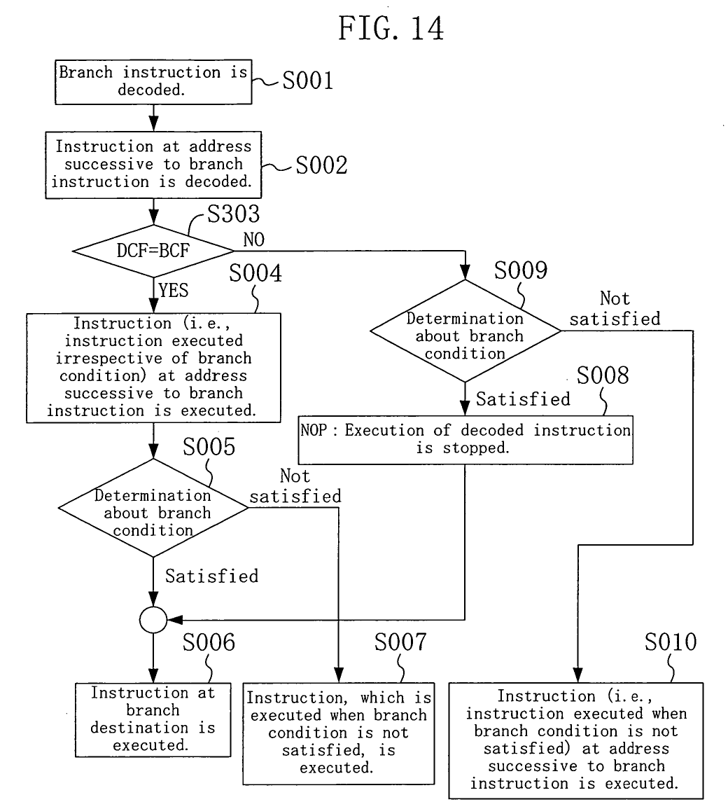

Specifically, as shown in FIG. 13A, when an instruction code at an address (N+1) is an instruction that is executed irrespective of whether or not the branch condition in the conditional branch instruction is satisfied, the value of the condition field 400a is set to DCF=BCF, and when the instruction code at the address (N+1) is an instruction that is executed only when the branch condition is not satisfied, the value of the condition field 400a is set to DCF≠BCF. That is, as shown in FIG. 14, whether or not a delayed branch is taken is controlled based on whether or not the value of DCF is equal to the value of BCF (S303). This enables the instruction codes to be processed in orders similar to those described in the first embodiment or the like, as shown in FIGS. 13B and 13C.

Consequently, the same effects as those of the first embodiment are also achieved in this embodiment. In addition, in this embodiment, since the branch control is performed by comparing the branch condition of the conditional branch instruction and the execution condition for the instruction located at the successive address, a delayed-slot instruction field 100a such as described in the first embodiment does not need to be provided separately.

### Fifth Embodiment

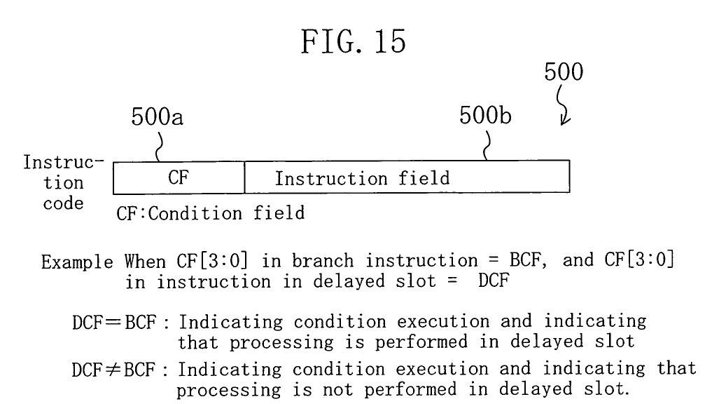

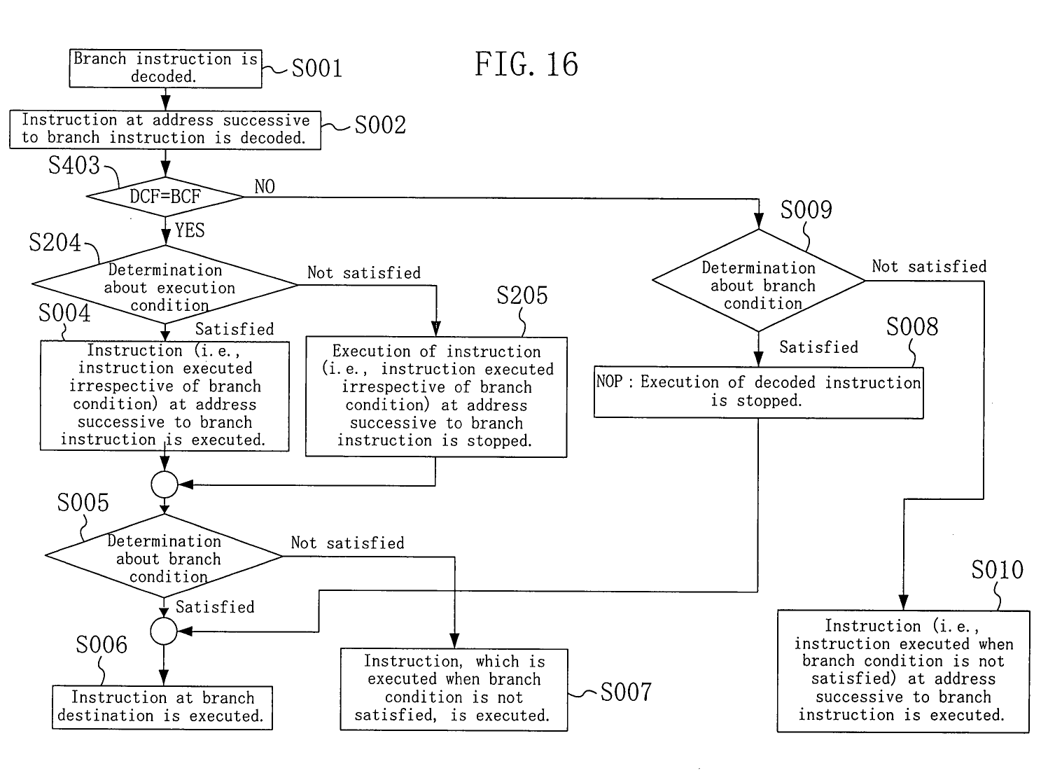

As shown in FIG. 15, by using an instruction code 500 (conditional execution instruction) that contains a condition field 500a and an instruction code 500b like the instruction code described in the fourth embodiment, branch operation may be controlled by comparing a branch condition (BCF) in a conditional branch instruction and an execution condition (DCF) for the instruction code located at the address subsequent to the conditional branch instruction, and in addition, the DCF may be used as a condition field in the conditional execution instruction. Specifically, as shown in FIG. 16, whether or not a delayed branch is implemented may be controlled based on whether or not the value of BCF is equal to the value of DCF (S403), while control may be performed based on the value of the DCF in such a manner that a so-called conditional execution is performed both in the case in which the delayed branch is implemented (S204, S205, S004) and in the case in which a normal branch is caused (S010).

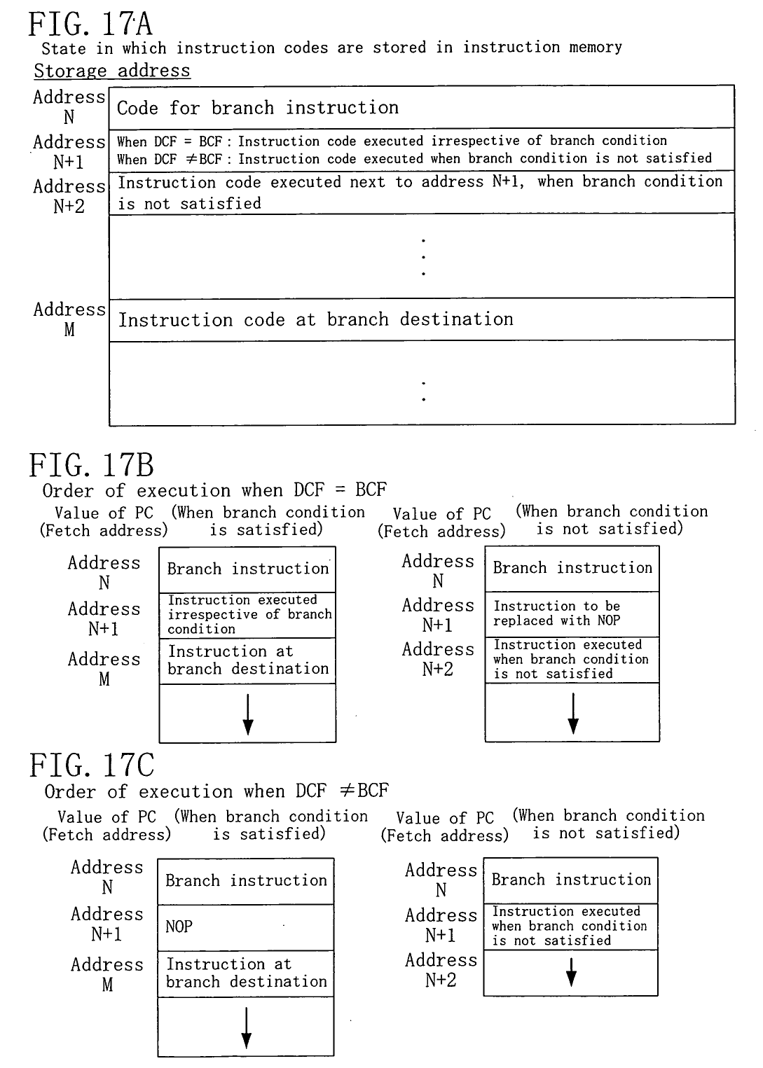

To be specific, as shown in FIG. 17A, when an instruction code at an address (N+1) is an instruction that is executed irrespective of whether or not the branch condition of the conditional branch instruction is satisfied, BCF=DCF is established, and when the instruction code at the address (N+1) is an instruction that is executed only when the branch condition is not satisfied, BCF≠DCF is established.

This enables the instruction codes to be processed in orders similar to those described in the first embodiment or the like as shown in FIGS. 17B and 17C, while allowing a conditional execution to be performed for the instruction code stored at the address (N+1).

Moreover, in the case where BCF=DCF is established, the branch condition of the conditional branch instruction agrees with the execution condition for the execution instruction at the successive address. Therefore, when the branch condition is satisfied, the instruction at the successive address is executed, and when the branch condition is not satisfied, the instruction at the successive address is not executed. This allows an instruction located at the branch destination to be stored at the address successive to the conditional branch instruction.

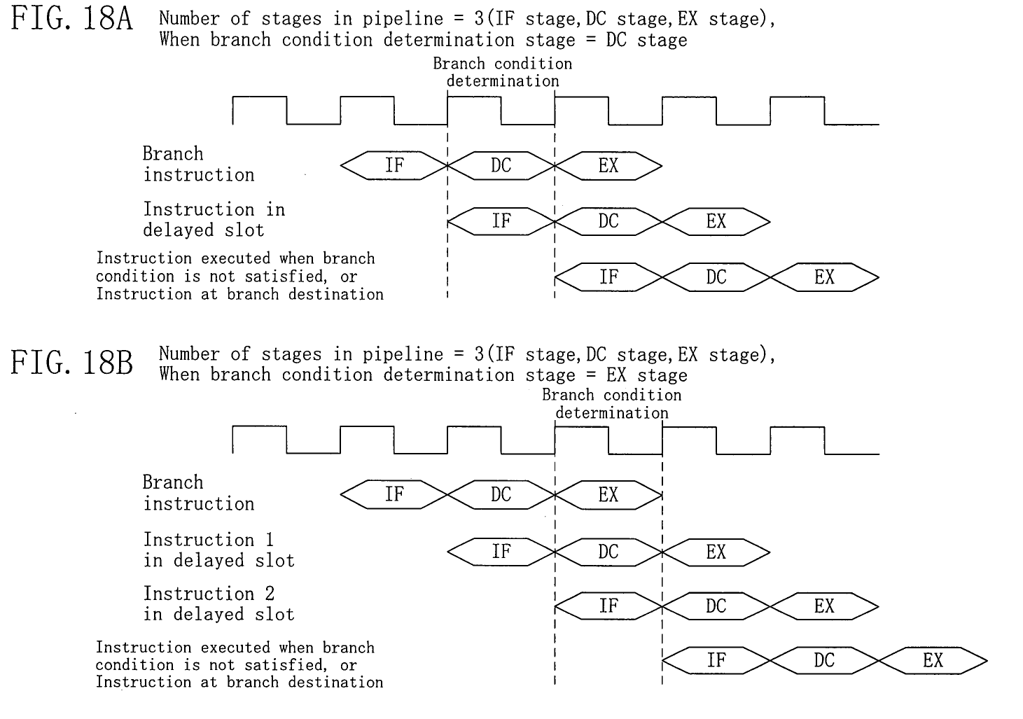

The foregoing embodiments have been described assuming that the delayed slot is only the slot located next to the conditional branch instruction, because the three-stage pipeline processing is performed and the decision about the branching of the conditional branch instruction is made in the DC stage, as shown in FIG. 18A. However, as shown in FIG. 18B, for example, if the decision about the branching is made in the EX stage, or if the number of stages existing in the pipeline is four or more, two or more delayed slots occur. Even in these cases, the same effects as those described above are achieved. For example, suppose a case in which the number of delayed slots produced is N. In this case, when a delayed branch is implemented, S003 and S004 shown in FIG. 3 may be repeated N times. Also, when no delayed branch is implemented and the branch condition is satisfied, S003 and S009 may be performed and then S008 may be repeated N times. When no delayed branch is implemented and the branch condition is not satisfied, S003 and S009 may be performed and then S010 may be performed. In this way, the above-described effects are achievable. It should be noted that in the above case, the value of DF (delayed-slot instruction field 100a) may be established only for the instruction code processed in the first delayed-slot, for example, so that the determination in S003 is made only once.

Also, as described in the first embodiment, in the case where no delayed branch is implemented, the execution of the instruction fetched from the address (N+1) may be blocked as in the case where the branch condition is satisfied, even if the branch condition is not satisfied, and the instruction at the address (N+1) may be again fetched, decoded, and executed.

Furthermore, the number of bits in each field, the correspondences between the set values and the contents indicated by those set values, and the like, described in the foregoing embodiments, are merely examples, and the present invention is not limited to these.

As described above, in the branch control method and the information processor according to the present invention, when an instruction that can be processed in a delayed slot is present, a delayed branch is implemented so as to eliminate a branch hazard, and even when there is no such an instruction, the program does not increase in size because insertion of NOP is not required. Therefore, the inventive information processor and the inventive branch control method are applicable to an information processor which performs pipeline processing of instructions and a method for controlling branching in the information processor.

1. A branch control method for controlling branch operation performed by a branch instruction in an information processor that performs pipeline processing in which instructions stored in storing means are fetched sequentially, the method comprising:
a discrimination step for discriminating, based on branch-control instruction information contained in an instruction code, between a first control mode, in which a succeeding instruction fetched following the branch instruction from an address successive to the branch instruction is executed regardless of whether or not a branch condition in the branch instruction is satisfied, and a second control mode, in which the succeeding instruction is executed when the branch condition is not satisfied; and
a control step for performing control in such a manner that
in the first control mode, the fetched succeeding instruction is executed, while branch control is performed according to whether or not the branch condition is satisfied,
in the second control mode, if the branch condition is satisfied, the succeeding instruction is fetched but is not executed, while an instruction at a branch destination is fetched and executed, and
in the second control mode, if the branch condition is not satisfied, the succeeding instruction is executed.

2. The method of claim 1, wherein in the control step, control is performed in such a manner that in the second control mode, if the branch condition is not satisfied, the succeeding instruction is fetched following the branch instruction, and is executed.

3. The method of claim 1, wherein in the control step, control is performed in such a manner that in the second control mode, if the branch condition is not satisfied, the succeeding instruction is fetched following the branch instruction, but is not executed, and thereafter the succeeding instruction is fetched again and executed.

4. The method of claim 1, wherein the branch-control instruction information is contained in an instruction code of the instruction at the address successive to the branch instruction.

5. The method of claim 1, wherein the succeeding instruction contains instruction-execution-condition information that indicates one or more instruction execution conditions for execution of the instruction;
in the control step, control is performed in such a manner that in the second control mode, if the branch condition is not satisfied and the one or more instruction execution conditions of the succeeding instruction are satisfied, the instruction is executed; and
in the discrimination step, it is determined that the first control mode is indicated, when the instruction-execution-condition information has a predetermined value.

6. The method of claim 1, wherein the succeeding instruction contains instruction-execution-condition information that indicates one or more instruction execution conditions for execution of the instruction; and
in the control step, control is performed in such a manner that
in the first control mode, if the one or more instruction execution conditions of the succeeding instruction are satisfied, the instruction is executed, and
in the second control mode, if the branch condition is not satisfied and the one or more instruction execution conditions are satisfied, the succeeding instruction is executed.

7. The method of claim 1, wherein the succeeding instruction contains instruction-execution-condition information that indicates one or more instruction execution conditions for execution of the instruction; and
in the discrimination step, the discrimination between the first control mode and the second control mode is made according to whether the instruction-execution-condition information of the succeeding instruction agrees with the branch condition of the branch instruction.

8. The method of claim 7, wherein in the control step, control is performed in such a manner that in the first control mode, the succeeding instruction is executed regardless of the instruction-execution-condition information.

9. The method of claim 7, wherein in the discrimination step, it is determined that the first control mode is indicated, when the instruction-execution-condition information of the succeeding instruction agrees with the branch condition of the branch instruction; and
in the control step, in the first control mode, whether or not to execute the succeeding instruction is controlled according to the instruction-execution-condition information.

10. An information processor which performs pipeline processing of instructions, comprising:
a fetch section for sequentially fetching the instructions stored in storing means;
a decoding section for decoding the fetched instructions;
an instruction execution section for executing the decoded instructions;
discrimination means for discriminating, based on branch-control instruction information contained in an instruction code, between a first control mode, in which a succeeding instruction fetched following a branch instruction from an address successive to the branch instruction is executed regardless of whether or not a branch condition in the branch instruction is satisfied, and a second control mode, in which the succeeding instruction is executed when the branch condition is not satisfied; and
control means for performing control in such a manner that
in the first control mode, the fetched succeeding instruction is executed, while branch control is performed according to whether or not the branch condition is satisfied,
in the second control mode, if the branch condition is satisfied, the succeeding instruction is fetched but is not executed, while an instruction at a branch destination is fetched and executed, and
in the second control mode, if the branch condition is not satisfied, the succeeding instruction is executed.
